(19) United States
(12) Patent Application Publication
(10) Pub. No.: US 2003/0106498 A1
(43) Pub. Date: Jun. 12, 2003

(54) Pet food serving apparatus and methods

(76) Inventors: Thomas Mersits, Santa Fe Springs, CA (US); Erlend M. Olson, Duarte, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/013,806

(22) Filed: Dec. 7, 2001

(51) Int. Cl. A01K 1/10; A01K 5/00; A01K 39/00

(52) U.S. Cl. 119/61

(57) ABSTRACT

The present invention is directed to a pet food apparatus for protecting pet food containers from crawling insects. The food containers are located on an upper tray, elevated above a moat tray, which contains water or some other liquid or attractant. The liquid attracts the crawling insects that have come to the vicinity of the pet food apparatus and the insects get trapped in the liquid or other attractant. One or more vertical support structures support the upper tray above the moat tray. The support structures are configured to enable a user to set the height of the elevated tray relative to the moat tray or the ground. The elevated tray can also be configured with cutout or recessed sections to fit matching pet food bowls. A built-in water dispenser can automatically maintain the fluid level in the moat tray.

### BACKGROUND OF THE INVENTION

1. Field of the Invention

The present invention relates to pet food serving devices, and in particular, to methods and apparatus for reducing insect intrusion into pet food serving devices.

2. Description of the Related Art

Pet owners typically use pet food containers, such as bowls or trays, to provide food and water for their pets. A common problem that occurs when animal food is placed in a pet food dish is that, after some period of time, ants and other crawling insects are attracted to and infest the food and water. Many pets do not want to eat food that has been contaminated by insects.

Conventional attempts to address this problem include a variety of pet food dishes with a small moat or water barrier built into them. Disadvantageously, some conventional pet food dishes with moats can be difficult to clean and, due to the small size of the moats, are typically not very effective at preventing infestation. Other conventional attempted solutions include raising a pet food bowl off the ground, but some of these devices have been cumbersome or unstable. In addition, the height at which the conventional raised pet food bowl is fixed can make it uncomfortable for many smaller pets to use. Hence, conventional solutions have been unsatisfactory as they fail to adequately provide a comfortable, stable pet food tray that keeps insects out of the pet food.

### SUMMARY OF THE INVENTION

The present invention is directed to methods and apparatus for reducing ant and other insect infestation of pet food while providing a serving apparatus whose height can be suitably adjusted to correspond with the pet's height.

One embodiment of the present invention provides an elevated tray with one or more supports on which pet food dishes can be placed and further includes a lower tray with a moat for water. Insects attempting to reach pet food in the pet food dishes will crawl into the water-filled moats and drown. In particular, the multiple supports are vertical and have an adjustable height. This enables a user to adjust the height of the upper tray, which holds the food dishes, to a height suitable for a pet to eat from the dishes, while keeping the dishes off of the ground.

In another embodiment in accordance with the present invention, a supported elevated tray has cutouts shaped to match the food dish shape, so that food dishes will fit into the cutouts.

In another embodiment in accordance with the present invention, a supported elevated tray has recesses in it to support food bowls with a shape to match and fit into the recesses.

In another embodiment in accordance with the present invention, a single support with horizontal grooves in it can provide for adjusting the height or vertical displacement relative to the ground of an upper tray. The upper tray can contain or support the pet food directly or can support or hold pet food bowls which in turn contain or support the pet food.

These and other advantages in accordance with the present invention will become apparent from the following detailed description and the drawings.

### BRIEF DESCRIPTION OF THE DRAWINGS

FIG. 1 illustrates a first example pet food tray in accordance with the present invention.

FIG. 2 illustrates a second example pet food tray in accordance with the present invention, wherein an upper tray has cutouts to fit pet food bowls.

FIG. 3 illustrates a third example pet food tray in accordance with the present invention, wherein the upper tray has recesses to fit pet food bowls.

FIGS. 4A and 4B illustrate a fourth example pet food tray in accordance with the present invention, wherein a vertical support is notched to provide a choice of possible heights for the upper tray.

FIGS. 5A and 5B illustrate a fifth example pet food tray in accordance with the present invention, where the pet food tray can be assembled to provide a choice of possible heights for the upper tray.

FIGS. 6A and 6B illustrate a sixth example pet food tray in accordance with the present invention, where the pet food tray can be assembled to provide a choice of possible heights for the upper tray.

FIGS. 7A and 7B illustrate seventh example pet food tray in accordance with the present invention, where the pet food tray can be assembled to provide a choice of possible heights for the upper tray.

FIGS. 8A and 8B illustrate an eighth example pet food tray in accordance with the present invention, wherein the water level in a lower tray can be automatically maintained at a desired height.

FIG. 9 illustrates a ninth example pet food tray in accordance with the present invention, wherein multiple vertical spacers can be used to provide a choice of possible heights for the upper tray.

FIG. 10 illustrates a tenth example pet food tray in accordance with the present invention, where the upper and lower trays are of curved design.

### DETAILED DESCRIPTION OF PREFERRED EMBODIMENTS

The present invention advantageously provides a pet food feeding apparatus including an elevated food tray supported by one or more support structures. In addition, the feeding apparatus includes a lower tray with a moat for water. Insects attempting to reach pet food in the pet food tray will crawl into the water-filled moat and drown. Further, the one or more support structures can be used to adjust the height of the elevated tray relative to the ground. This enables a user to adjust the height of the elevated food tray to a height suitable for their pet to eat from, while keeping the food protected from insects. Descriptions of several example embodiments of the present invention are provided below.

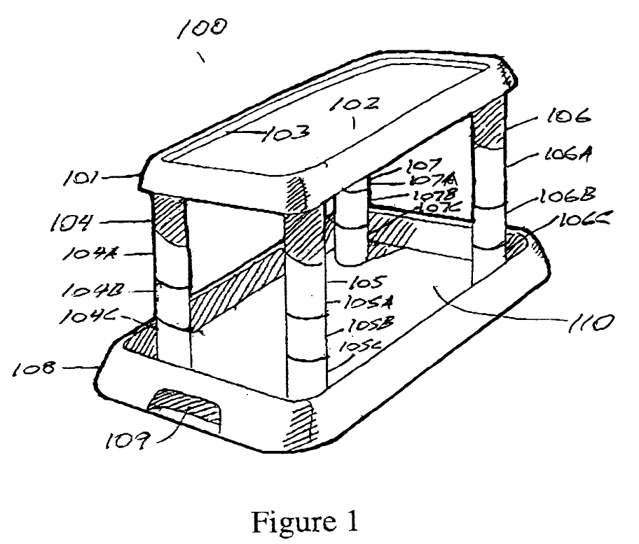

FIG. 1 illustrates a pet food serving apparatus 100 in accordance with the present invention. The apparatus 100 has an upper tray 101, supported by four posts 104, 105, 106 and 107 and connected to a lower tray 108. While the illustrated trays 101, 108 are rectangular in shape, or shapes, such as a circular or square shape, can be used as well. In the embodiment shown, the vertical posts 104, 105, 106 and 107 are each made of three sections A, B and C. Upper tray 101 is of sufficient size to fit two food dishes or bowls, (not shown), one bowl for food and a second bowl for water. In another embodiment, rather than support food dishes, pet food can be directly placed in the upper tray 101.

The upper tray 101 has a recessed area 102 with an inner side wall 103 to prevent the food bowls from being pushed off the tray by an animal such as, a dog or cat, while feeding. The lower tray 108 has a recessed area 110 of sufficient depth to contain a large amount of water or other fluid or liquid to trap any ants or other crawling insects. Other fluids, such as detergents, insecticides or insect attractants, can be placed in the lower tray 108. In addition, rather than a liquid or fluid, the lower tray 108 can be filled with a paste, glue or other substance that can trap and/or kill crawling insects.

Insects attempting to reach the food in the bowls on the upper tray will first enter into the water in the lower tray 108 and will then be trapped and drowned. In particular, the water in the lower tray 110 attracts crawling insects and prevents the insects from crawling up any of the vertical posts 104, 105, 106 and 107 and from reaching the upper tray 101 and the food bowls. To ease gripping and lifting of the apparatus 100, two handles are provided. A first handle 109 is located on a side wall 112 of the lower tray 108 and a second handle (not shown) is located on the opposite exterior side wall 114 of the lower tray 108.

The example apparatus 100 illustrated in FIG. 1 can be manufactured in several different sizes and shapes, to accommodate pets of various sizes. One of the advantages of the apparatus 100 is that various size bowls can be placed on the upper tray. The upper tray can be made of a size sufficient to fit the commonly available pet food bowls, such as those found in pet supply stores.

Advantageously, the multiple supporting posts 104, 105, 106 and 107 provide more stability to the upper tray 101, as compared to a single post design. The apparatus 100 can be made of any of a variety of suitable materials, such as, plastic, metal, wood or a combination of materials commonly used for pet food bowls and trays. A pet food serving apparatus 100 can, for example, be made of plastic and be packaged and sold in an assembled or disassembled form. If the apparatus 100 is sold in a disassembled form, then the user can adjust the height of the upper tray 101 relative to the lower tray 108 during assembly. As noted above, the vertical posts 104, 105, 106, 107 are each made of three sections: A, B and C. The three interconnecting sections of each post can be made in such a manner as to provide for assembly of the apparatus 100 using one, two or all three sections A, B, C and thereby adjust the height of the upper tray 101. For example, each section can have a male mating end and a female mating end, wherein the male mating end mates with a female mating end of an adjacent section or of the lower 108 or upper tray 101. Both the female and male mates can be treaded so that the sections can be screwed together. Alternatively, the male mate can be a plastic expansion structure that forms a compression fit with a female mate of an adjoining section or tray. The vertical supporting posts 104, 105, 106, 107 can be made of as many sections as needed, in order to provide as many different upper tray heights as are desired. While the posts 104-107 are illustrated as being round columns, other shapes, such as oval or square shapes, can be used as well.

It should also be noted that the number of vertical posts used to support an upper tray 101 is not limited to four, but could be less or more, as needed or desired to support a particular size and shape upper tray. In addition, the size and shape of the upper tray 101 can be adjusted to accommodate only one food dish, or more than two food dishes.

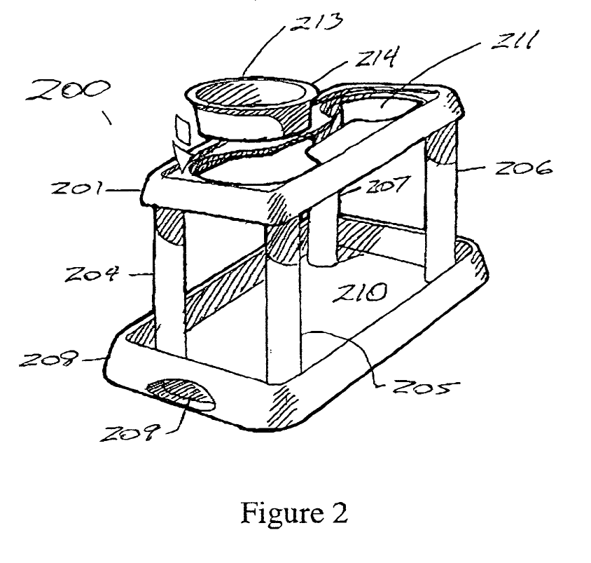

FIG. 2 illustrates an alternate embodiment of the pet food tray in accordance with the present invention. A pet food serving apparatus 200 has an upper tray 201, supported by four posts 204, 205, 206 and 207 and connected to a lower tray 208. The upper tray 201 is of sufficient size to fit two matching food dishes or bowls, one for food and a second for water. For the sake of clarity, only one bowl 213 is illustrated. While the illustrated bowl is round in shape, other shapes, such as a rectangular or square shape, can be used as well. The upper tray 201 has a cutout 211, which is sized to fit the bottom of the food bowl 213 and a second bowl of identical size and shape. The food bowl 213 has a larger diameter at its upper rim 214 than that of the corresponding portion of the cutout 211 to prevent the bowl 213 from falling through the cutout 211. The rim 214 of the bowl 213 also provides a handle for lifting the bowl 213 off of the tray 201. The lower tray 208 has a recessed area 210 of sufficient depth to contain a large amount of water or other fluid to trap ants or other crawling insects.

Insects that may be in the vicinity due to the food in the bowls on the upper tray 201, will be attracted to the water in the lower tray 208 and get trapped in it. The water in the lower tray 208 attracts the crawling insects and prevents them from crawling up any of the vertical posts 204, 205, 206 or 207 and from reaching the upper tray 201 and the food bowls. A first handle 209 is located on a side wall 212 of the lower tray 208 and a second handle (not shown) is located on the opposite exterior side wall 214 of the lower tray 208.

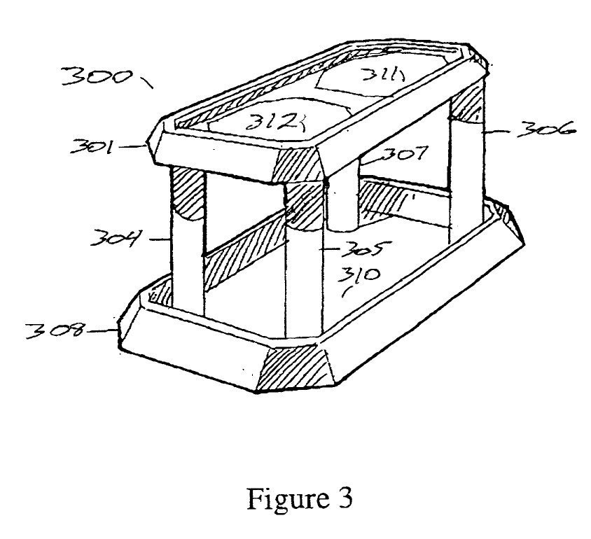

FIG. 3 illustrates another alternate embodiment of the pet food tray in accordance with the present invention. A pet food serving apparatus 300 has an upper tray 301, supported by four posts 304, 305, 306 and 307 and connected to a lower tray 308. The upper tray 301 is of sufficient size to fit two matching food dishes or bowls (not illustrated), though in other embodiments can be sized and shaped to hold fewer or more bowls. The upper tray 301 has recessed sections 311 and 313, which are sized to closely fit or surround the bottom of two food bowls. The lower tray 308 has a recessed area 310 of sufficient depth to contain a large amount of water or other fluid to trap any ants or other crawling insects.

Insects that may be in the vicinity due to the food in the bowls on the upper tray will be attracted to the water in the lower tray and get trapped in it. The water in the lower tray 310 attracts the crawling insects and prevents them from crawling up any of the vertical posts 304, 305, 306 or 307 and from reaching the upper tray 301 and the food bowls.

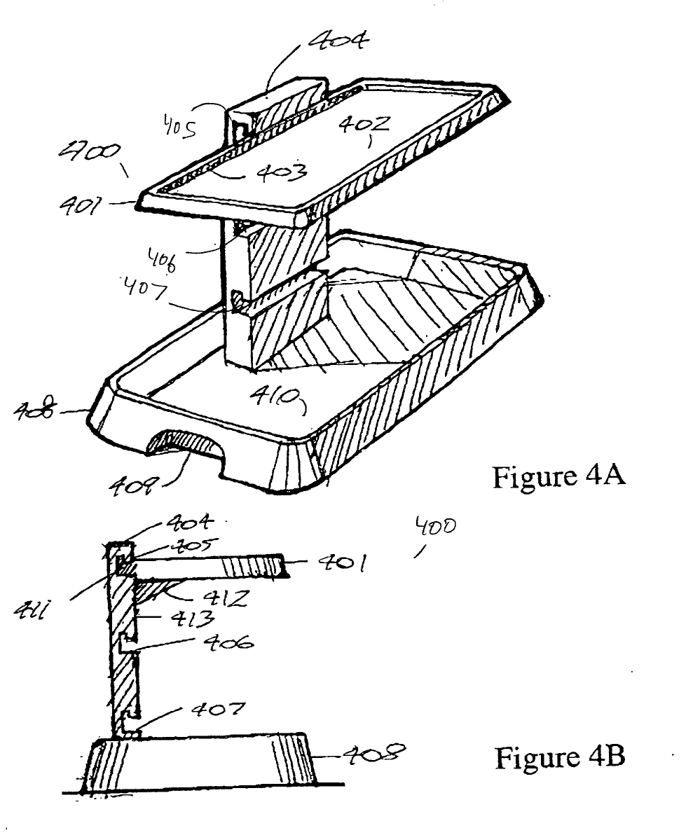

FIGS. 4A and 4B illustrate still another example embodiment of a pet food apparatus 400 in accordance with the present invention. The serving apparatus 400 has an upper tray 401, supported by a post 404 and connected to a lower tray 408. In the embodiment shown, the vertical post 404 has three horizontal notches or grooves 405, 406 and 407 though fewer or more grooves can be provided. In this example, the grooves are L-shaped when viewed from the side. Upper tray 401 is of sufficient size to fit two food bowls, (not shown), one for food and a second for water, though as similarly discussed above, the tray 401 can be sized to hold fewer or greater number of bowls or containers. The upper tray 401 has a recessed area 402 with an inner side wall 403 to prevent the food bowls from being pushed off the tray by an animal such as, a dog or cat, while feeding. The lower tray 408 has a recessed area 410 of sufficient depth to contain a large amount of water or other fluid to trap any ants or other crawling insects.

Insects that may be in the vicinity due to the food in the bowls on the upper tray will be attracted to the water in the lower tray and get trapped in it. The water in the lower tray 410 attracts the crawling insects and prevents them from crawling up the vertical post 404 and up to the upper tray 401 with its food bowls. A carrying handle 409 is provided on the side of the lower tray 410, and a second handle (not shown) is located on the opposite exterior wall of the lower tray 410.

The pet food apparatus 400 can, for example, be made of plastic and be sold in a disassembled form. The height of the upper tray 401 is determined by which of the three horizontal grooves 405, 406 and 407 are used to support the tray 401. The user can selectively mount the tray 401 in one of the grooves 405-407 and if the height is not satisfactory, move the tray 401 to a different groove. The tray 401 has a raised lip 411 on one of its long sides 414, which fits into a matching portion of any of the horizontal grooves 405, 406 or 407. The bottom of the tray 401 has a triangular section 412, which supports the tray 401, by pressing against a side 413 of support post 404. The vertical support post 404 can have as many grooves as needed, in order to provide as many different upper tray heights as are desired.

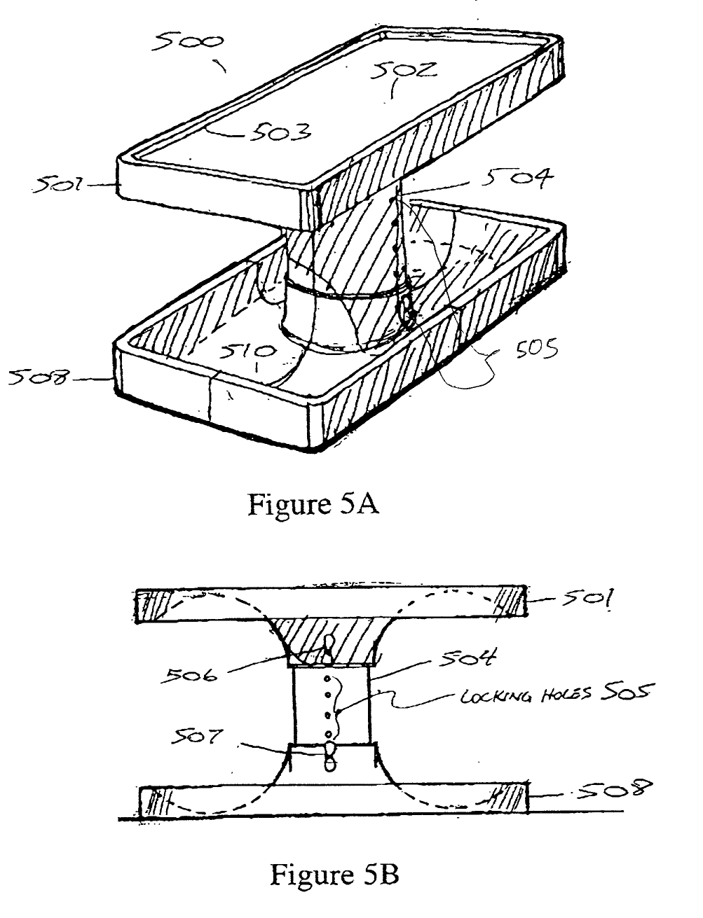

FIG. 5A illustrates an elevational view of still another alternate embodiment of the pet food serving apparatus 500 in accordance with the present invention. FIG. 5B illustrates a side view of pet food apparatus 500 in accordance with the present invention. The apparatus 500 has an upper tray 501, supported by a post 504 and connected to a lower tray 508. In the embodiment shown, the vertical post 504 includes a series of openings or holes 505, used to set the height of the upper tray. The openings 505 can be threaded to receive a mating locking device, such as a screw. In this example, upper tray 501 is of sufficient size to fit two food bowls, (not shown), one for food and a second for water, though the tray 501 can be sized to hold more or fewer dishes or bowls. The upper tray 501 has a recessed area 502 with an inner side wall 503 to prevent the food bowls from being pushed off the tray by an animal such as, a dog or cat, while feeding. The lower tray 508 has a recessed area 510 of sufficient depth to contain a large amount of water or other fluid to trap any ants or other crawling insects.

Insects that may be in the vicinity due to the food in the bowls on the upper tray will be attracted to the water in the lower tray and get trapped in it. The water in the lower tray 510 attracts the crawling insects and prevents them from crawling up the vertical post 504 and up to the upper tray 501 with its food bowls.

A pet food apparatus 500 can, for example, be made of plastic and be sold in a disassembled form. The height of the upper tray 501 is determined by which of the holes 505 are used to attach the upper and lower trays to the post 504. Screws 506 and 507 with wing nut heads or other attachment apparatus inserted or screwed into two of the holes 505 are used to connect the upper and lower trays 501, 508 to the post 504. Alternatively, slotted screws or the like without wing nut heads can be interested into corresponding holes 505. There can be several holes 505 as are needed to provide as many different upper tray heights as are desired. In other embodiments, different height setting mating mechanisms can be used. For example, plastic expansion fasteners, which mate with a corresponding post mating hole or channel, can be used in place of the wing nuts.

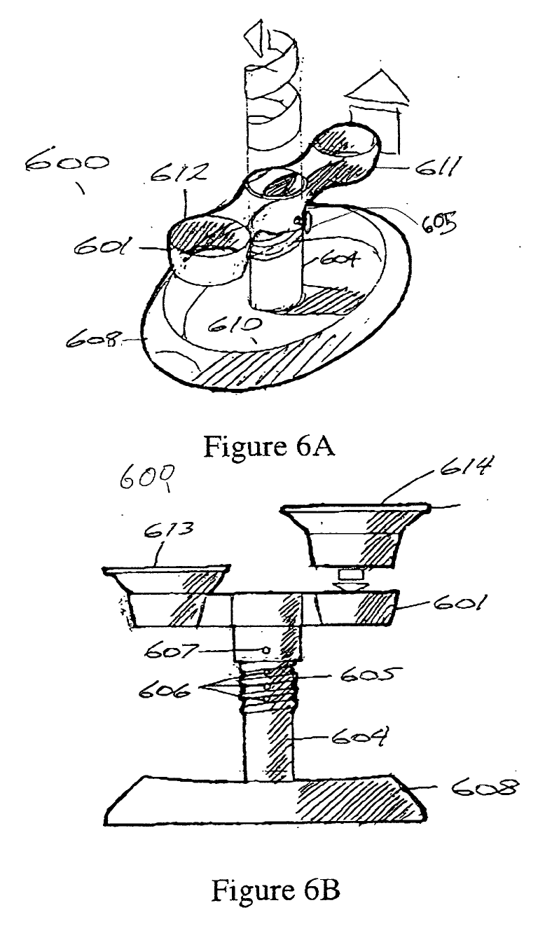

FIG. 6A illustrates an elevational view of an alternate embodiment of the pet food serving apparatus 600 in accordance with the present invention. FIG. 6B illustrates a side view of pet food apparatus 600 in accordance with the present invention. The apparatus 600 has an upper tray 601, supported by a post 604 and connected to a lower tray 608. In the embodiment shown, the vertical support post 604 is threaded 605. To give a large height adjustment range, the support post 604 can be threaded for more than half its length. In order to hold the upper tray 601 at a fixed height, the post 604 has a series of height set structures, in this example, holes 606. The user spins the upper tray 601 on the post 604 to a desired height. Screws, dowels, or pins can then be inserted into a hole 606 to fixedly set the height. If screws are used to set the height, then the holes 606 can be threaded. Upper tray 601 is of sufficient size to fit two food bowls, (not shown), one for food and a second for water. The upper tray 601 has two rings 611 and 612, into which matching food bowls 613 and 614 can be inserted. The rings 611, 612 can be open at the bottom as well as at the top to better accommodate bowls of various heights and sizes. In this example, each bowl has two conical sections, wherein the top section has a wider diameter and shallower sloping walls than the bottom section. This prevents the food bowls 613, 614 from slipping through the corresponding rings 611, 612. The lower tray 608 has a recessed area 610 of sufficient depth to contain a large amount of water or other fluid to trap any ants or other crawling insects.

Insects that may be in the vicinity due to the food in the bowls on the upper tray will be attracted to the water in the lower tray and get trapped in it. The water in the lower tray 610 attracts the crawling insects and prevents them from crawling up the vertical post 604 and up to the upper tray 601 with its food bowls.

The pet food apparatus 600 can, for example, be made of plastic and be sold in a disassembled form. The bottom of the upper tray 601 has an internally threaded section (not shown), which matches the external threads 605 on the post 604. The apparatus 600 is assembled by spinning the upper tray 601 onto the post 604. As the tray 601 and the post 604 are spun together to the desired height, one of the holes 606 will line up with hole 607, so that a screw, pin or other fastener can be inserted to lock the tray 601 and post 604 together. There can be several holes 606 as needed to provide as many different upper tray heights as are desired.

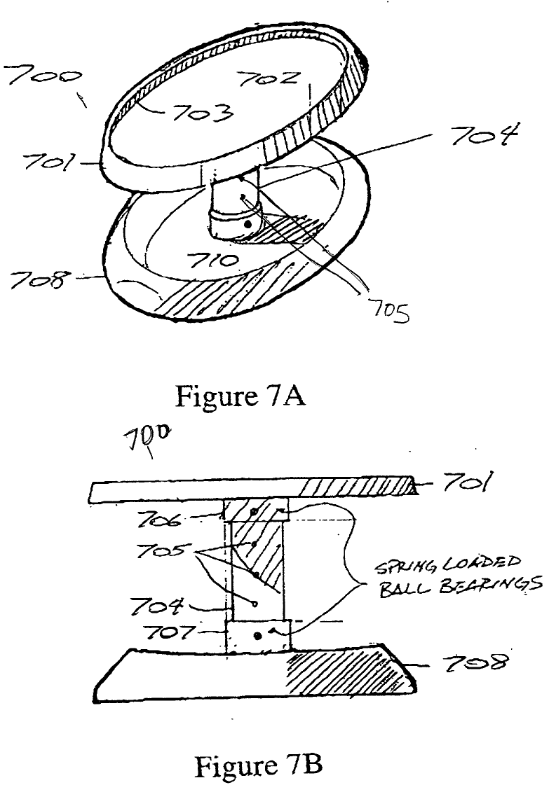

FIG. 7A illustrates an alternate embodiment of the pet food apparatus 700 in accordance with the present invention. FIG. 7B illustrates a side view of pet food apparatus 700 in accordance with the present invention. The apparatus 700 has an upper tray 701, supported by a post 704 and connected to a lower tray 708. In the embodiment shown, the vertical post 704 includes a series of holes 705, used to set the height of the upper tray. Upper tray 701 is of sufficient size to fit two food bowls, (not shown), one for food and a second for water. The upper tray 701 has a recessed area 702 with an inner side wall 703 to prevent the food bowls from being pushed off the tray by an animal such as, a dog or cat, while feeding. The lower tray 708 has a recessed area 710 of sufficient depth to contain a large amount of water or other fluid to trap any ants or other crawling insects.

Insects that may be in the vicinity due to the food in the bowls on the upper tray will be attracted to the water in the lower tray and get trapped in it. The water in the lower tray 710 attracts the crawling insects and prevents them from crawling up the vertical post 704 and up to the upper tray 701 with its food bowls.

A pet food apparatus 700 can, for example, be made of plastic and be sold in a disassembled form. The height of the upper tray 701 is determined by which of the holes 705 are used to attach the upper and lower trays to the post 704. Spring loaded ball bearings 706 and 707 are used to connect the trays 701 and 708 to the post 704. Each of the spring-loaded ball bearings 706 and 707 couples the trays 701 and 708 to the post 704 by pressing into one of the holes 705 in the post 704. The use of spring loaded ball bearings to connect a post to a collar, as in this embodiment of the invention is well known to those skilled in the art. There can be several holes 705 as are needed to provide as many different upper tray heights as are desired.

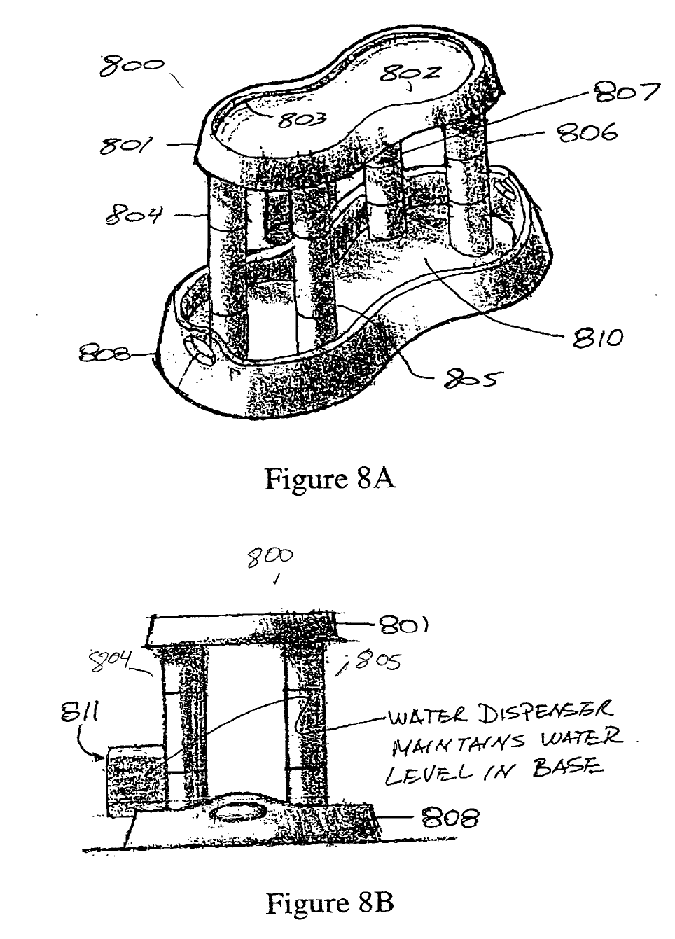

FIG. 8A illustrates an elevational view of another alternate embodiment of the pet food serving apparatus 800 in accordance with the present invention. FIG. 8B illustrates a side view of pet food serving apparatus 800 in accordance with the present invention. The apparatus 800 has an upper tray 801, supported by four posts 804, 805, 806 and 807 and connected to a lower tray 808. The upper tray 801 is of sufficient size to fit two food bowls, (not shown), one for food and a second for water, though the tray can be sized to hold fewer or more bowls or dishes. The upper tray 801 has a recessed area 802 with an inner side wall 803 to prevent the food bowls from being pushed off the tray by an animal such as, a dog or cat, while feeding. The lower tray 808 has a recessed area 810 of sufficient depth to contain a large amount of water or other fluid to trap any ants or other crawling insects. A water dispenser 811 having a floating device is used to maintain the water level in the base 810 at a predetermined level or within a level range, such as within ±0.25″, ±0.5″ inches or ±1″.

Insects that may be in the vicinity due to the food in the bowls on the upper tray will be attracted to the water in the lower tray 810 and will crawl into water and become trapped and drown in it. The water in the lower tray 810 attracts the crawling insects and prevents them from crawling up any of the vertical posts 804, 805, 806 and 807 and up to the upper tray 801 and the food bowls.

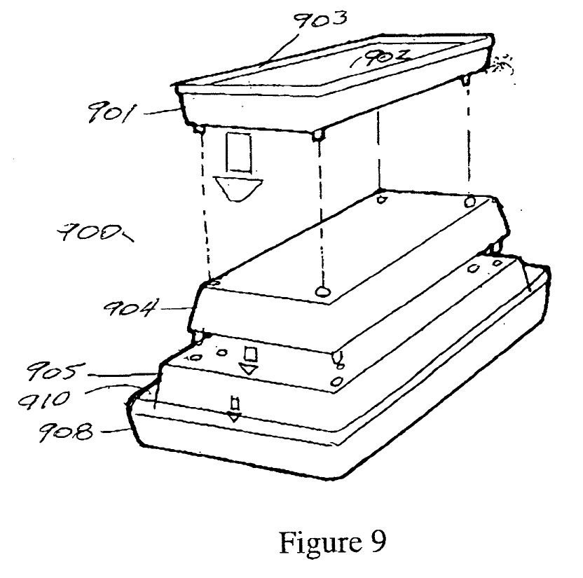

FIG. 9 illustrates an alternate embodiment of the pet food apparatus 900 in accordance with the present invention. The apparatus 900 has an upper tray 901, supported by a spacer 904, which is supported by a second spacer 905 and connected to a lower tray 908. The upper tray 901 is of sufficient size to fit two food bowls, (not shown), one for food and a second for water. The upper tray 901 has a recessed area 902 with an inner side wall 903 to prevent the food bowls from being pushed off the tray by an animal such as, a dog or cat, while feeding. The lower tray 908 has a recessed area 910 of sufficient depth to contain a sufficient or large amount of water or other fluid to trap any ants or other crawling insects.

Insects that may be in the vicinity due to the food in the bowls on the upper tray 901 will be attracted to the water in the lower tray 908 and get trapped in it. The water in the lower tray 910 attracts the crawling insects and prevents them from crawling up the spacers 904 and 905 to the upper tray 901 and the food bowls.

The embodiment shown in FIG. 9 can be manufactured in several different sizes and shapes, to accommodate pets of various sizes and heights. One of the advantages of the apparatus 900 is that various size bowls can be placed on the upper tray 901. The upper tray 901 can be made of a size sufficient to fit the commonly available pet food bowls, as found in pet supply stores.

The apparatus 900 can be made of any of a variety of suitable materials, such as, without limitation, plastic, metal, wood or a combination of materials commonly used for pet food bowls and trays. The pet food apparatus 900 can be made of plastic and can be packaged and sold in a disassembled form. If the apparatus 900 is sold in a disassembled form, then the user can adjust the height of the upper tray 901 during assembly. In FIG. 9, two spacers 904 and 905 are shown, and more or less spacers can be used as needed to adjust the height of the upper tray.

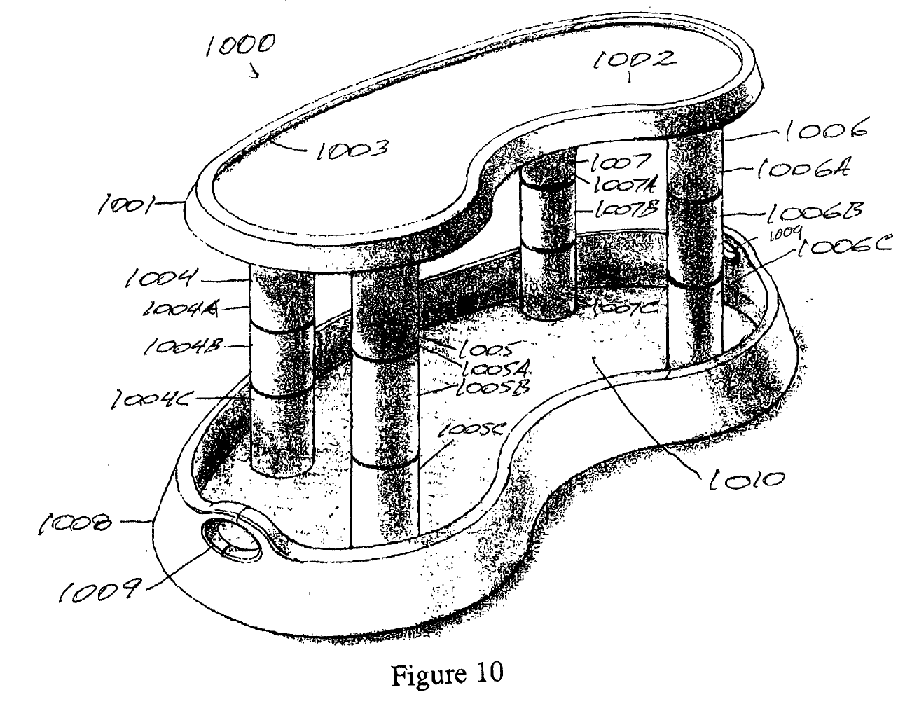

FIG. 10 illustrates a pet food serving apparatus 1000 in accordance with the present invention. The apparatus 1000 has an upper kidney-shaped apparatus 1001, supported by four posts 1004, 1005, 1006 and 1007 and connected to a lower kidney-shaped apparatus 1008. In the embodiment shown, the vertical posts 1004, 1005, 1006 and 1007 are each made of three sections A, B and C. Upper apparatus 1001 is of sufficient size to fit two food bowls, (not shown), one for food and a second for water. The upper apparatus 1001 has a recessed area 1002 with an inner side wall 1003 to prevent the food bowls from being pushed off the tray by an animal such as, a dog or cat, while feeding. The lower apparatus 1008 has a recessed area 1010 of sufficient depth to contain a sufficient amount of water or other fluid to trap ants or other crawling insects.

Insects that may be in the vicinity due to the food in the bowls on the upper tray 1001 will be attracted to the water in the lower tray 1008 and will enter the water, become trapped, and drown. The water in the lower tray 1010 attracts the crawling insects and prevents them from crawling up any of the vertical posts 1004, 1005, 1006 and 1007 and up to the upper apparatus 1001 and the food bowls. Two handles 1009 are provided on the sides of the lower tray 1008.

The embodiment shown in FIG. 10 can be manufactured in several different sizes and shapes, to accommodate pets of various sizes and heights. One of the advantages of the apparatus 1000 is that various size bowls can be placed on the upper tray 1001. The upper tray 1001 can be made of a size sufficient to fit the commonly available pet food bowls, as found in pet supply stores.

The multiple supporting posts 1004, 1005, 1006 and 1007 provide greater stability to the upper tray 1001, as compared to a single post design.

The apparatus 1000 can be made of any of a variety of suitable materials, such as, plastic, metal, wood or a combination of materials commonly used for pet food bowls and trays. The pet food serving apparatus 1000 can, for example, be made of plastic and be packaged and sold in an assembled or disassembled form. If the apparatus 1000 is sold in a disassembled form, then the purchaser can adjust the height of the upper apparatus 1001 during assembly. As noted above, the vertical posts 1004, 1005, 1006 and 1007 are each made of three sections: A, B and C. The three interconnecting sections of each post can be made in such a manner as to provide for assembly of the apparatus 1000 using one, two or all three sections and thereby adjust the height of the upper tray 1001. The vertical supporting posts 1004-1007 can be made of as many sections as needed, in order to provide as many different upper tray heights as are desired.

It should also be noted that the number of vertical posts used to support an upper tray is not limited to four, but could be less or more, as needed to support a particular size and shape upper tray.

As previously discussed, the example embodiments illustrated in the figures can be manufactured in several different sizes and shapes, to accommodate pets of various sizes.

Thus, the present invention provides a height-adjustable pet food tray that prevents insect infestation of pet food. Pets can thereby feed at a more comfortable height and not be bothered by annoying ants or other insects.

Although this invention has been described in terms of certain preferred embodiments, other embodiments that are apparent to those of ordinary skill in the art are also within the scope of this invention.

What is claimed is:

1. A pet food server useable with animals of different heights, the pet food server comprising:
a first tray configured to support at least one food container;
a second tray having a recessed area for containing a liquid intended to impede crawling insects from accessing the first tray; and
a plurality of vertical supporting structures having user-adjustable heights, the plurality of vertical supporting structures having corresponding upper portions and corresponding lower portions, wherein the upper portions are coupled to the first tray and the lower portions are coupled to the second tray to thereby support the first tray above the second tray.

2. The pet food server as defined in claim 1, further comprising a fluid dispenser configured to keep fluid in the second tray within a predetermined level range.

3. The pet food server as defined in claim 1, wherein the first tray includes at least a first cutout portion configured to hold at least two food containers.

4. The pet food server as defined in claim 3, further comprising two food containers.

5. The pet food server as defined in claim 1, wherein the first tray further comprises at least a first recessed region configured to hold the at least one food container.

6. The pet food server as defined in claim 1, wherein the first tray further comprises at least two recessed regions configured to hold at least two corresponding food containers.

7. The pet food server as defined in claim 1, wherein the plurality of vertical supporting structures include corresponding pluralities of user separable sub-sections.

8. The pet food server as defined in claim 1, wherein the second tray includes at least two handles.

9. The pet food server as defined in claim 1, wherein the first tray has an underside and the plurality of vertical supporting structures are coupled to the underside of the first tray.

10. A pet feeding apparatus, comprising:
a first structure configured to hold at least one pet food container,
a second structure having a recessed area of a first depth configured to hold a fluid substance; and
a height-adjustable support post having a first end configured to be coupled to the first structure and a second end configured to be coupled to the second structure so as to adjustably position the first structure over the second structure.

11. The pet feeding apparatus as defined in claim 10, wherein the height-adjustable support post includes a plurality of detachable sections.

12. The pet feeding apparatus as defined in claim 10, wherein the height-adjustable support post is threaded on its outside surface.

13. The pet feeding apparatus as defined in claim 10, wherein the first structure includes a plurality of recessed sections shaped to hold a corresponding plurality of pet food containers.

14. The pet feeding apparatus as defined in claim 10, wherein the first structure includes at least a first cutout region configured to suspend a plurality of pet food containers.

15. The pet feeding apparatus as defined in claim 10, wherein the adjustable support post is vertical.

16. A pet feeding apparatus, comprising:
a first structure configured to hold at least one pet food container, the first structure further comprising a first fastener receptacle;
a second structure having a recessed area of a first depth configured to hold an insect trapping substance, the second structure further comprising a second fastener receptacle;
a vertical support structure having an exterior surface defining a plurality of openings used to set the height of the first structure relative to the second structure;
a first fastener configured to be inserted into a first of the plurality of openings and into the first fastener receptacle; and
a second fastener configured to be inserted into a second of the plurality of openings and into the second fastener receptacle.

17. The pet feeding apparatus as defined in claim 16, further comprising a liquid dispenser configured to dispense the insect trapping substance into the second structure.

18. The pet feeding apparatus as defined in claim 16, wherein the first fastener has a winged head.

19. The pet feeding apparatus as defined in claim 16, wherein the first fastener is threaded.

20. A pet feeding apparatus, comprising:
an upper tray configured to support at least one type of pet food, the upper tray having a threaded bore open at a first end and a second end;
a lower tray having a recessed area of a first depth configured to hold a fluid substance; and
a support structure coupled to the lower tray, the support structure having a first threaded portion configured to rotatably mate within the threaded bore of the upper tray and the support structure having a plurality of height setting structures configured to set the height of the upper tray relative to the second tray.

21. The pet feeding apparatus as defined in claim 20, wherein the upper tray includes a plurality of ring-shaped holders configured to hold a corresponding plurality of pet food containers.

22. The pet feeding apparatus as defined in claim 21, wherein at least one of the plurality of pet food containers has a first conical shaped section and a second conical section, the second conical section having different dimensions than the first conical section.

23. The pet feeding apparatus as defined in claim 20, wherein the upper tray includes at least a first cutout region configured to suspend a plurality of pet food containers.

24. The pet feeding apparatus as defined in claim 20, further comprising a fluid dispenser configured to maintain a first level of fluid in the lower tray.

25. A pet feeding apparatus, comprising:
a first tray configured to support pet food;
a second tray having a recessed area of a first depth configured to hold a fluid substance; and
a support post coupled to the second tray, the support post having at least a first plurality of spaced grooves along its height, wherein each of the first plurality of grooves is configured to receive the first tray to thereby enable a user to select an elevation of the first tray.

26. The pet feeding apparatus as defined in claim 25, wherein the first tray has a lip configured to mate with one of the first plurality of spaced grooves at a time.

27. The pet feeding apparatus as defined in claim 25, wherein at least one of the spaced grooves is L-shaped.

28. A pet food server, the pet food server comprising:
a first tray configured to support pet food;
a second tray having a recessed area for containing a liquid intended to impede crawling insects from accessing the first tray; and
a first vertical supporting structure coupled to the second tray, the first vertical supporting structure configured to selectively receive the first tray at different vertical displacements relative to the second tray.

29. The pet food server as defined in claim 28, further comprising a liquid dispenser configured to maintain liquid in the second tray at a substantially constant height.

30. The pet food server as defined in claim 28, wherein the first tray is further configured to hold a pet food dish.

31. The pet food server as defined in claim 28, wherein the first tray is kidney shaped.
